(19) United States
(12) Patent Application Publication
(10) Pub. No.: US 2015/0056335 A1
(43) Pub. Date: Feb. 26, 2015

(54) SYSTEM AND METHOD FOR PRODUCING BREAD PRODUCTS

(71) Applicant: Elwha LLC, Bellevue, WA (US)

(72) Inventors: SAMUEL J. FAHEY-BURKE, SEATTLE, WA (US); NATHAN P. MYHRVOLD, MEDINA, WA (US); HUAN LARISSA ZHOU, SEATTLE, WA (US)

(21) Appl. No.: 13/974,256

(22) Filed: Aug. 23, 2013

(51) Int. Cl. A21D 13/00; A21D 8/06; A21C 11/16

(52) U.S. Cl. CPC A21D 13/0048; A21C 11/163; A21D 8/06
USPC 426/94; 99/353; 426/504; 118/13

(57) ABSTRACT

An improved system and method to produce a bread product is disclosed. Bread products that produced with the system and method are also disclosed. The bread products are intended for commercial manufacture with high volume and efficiency. The system and method produce bread products from multiple dough components; one dough component provides an interior core; another dough product provides an exterior layer. When the bread product is baked, a multi-component bread product is formed where the crumb is provided by the dough component of the interior core and the crust is provided by exterior surface of the dough component of the exterior layer. Any of a wide variety of types and forms and shapes and sizes and etc. of bread products may be produced. The system and method may be performed using any of a wide variety of production techniques. Each dough component may be formulated (and may include an improver) to facilitate the operation of the system and method and to provide a tasteful and appealing bread product.

### CROSS-REFERENCE TO RELATED APPLICATIONS

### Priority Applications

### [None]

### Related Applications

(a) U.S. Patent Application Ser. No. ______, entitled SYSTEM AND METHOD FOR PRODUCING BREAD PRODUCTS, naming N. Myhrvold, H. Zhou and S. Fahey-Burke as inventors, filed Aug. 23, 2013, with Docket no. 0712-038-002-000000, is related to and incorporated by reference in the present application; and (b) U.S. Patent Application Ser. No. ______, entitled SYSTEM AND METHOD FOR THE MANUFACTURE OF PIZZA PRODUCTS, naming N. Myhrvold, A. Chan, H. Zhou and S. Fahey-Burke as inventors, filed Aug. 23, 2013, with Docket no. 0712-038-003-000000, is related to and incorporated by reference in the present application.

### FIELD

The present invention relates to a system and method for producing bread products. The present invention also relates to bread products that can be manufactured with the system and method.

### BACKGROUND

It is well known to produce a bread product such as a bread loaf from a dough component. Such bread products are typically baked in an oven in a process that results in the transformation of the monolithic dough component into a central interior portion or crumb and a thin but readily discernible exterior surface or crust. In the preparation of a bread product the crust and crumb are finished or baked under identical operating conditions (e.g. temperature time humidity, air movement, etc.). The crust is formed by the Malliard reaction which occurs at the exposed surface of the dough component when the bread product is baked.

It is well-known that the crumb and crust of a baked bread product will typically exhibit different characteristics of, for example, color, texture and taste, notwithstanding that the crumb and crust are formed of the same dough component and baked under identical operating conditions. The crust of a bread product is readily visible and prominent and may in some contexts be an important consideration in customer selection or preference.

That the bread product is baked as a monolithic form constrains the ability in production to establish significant variations in the characteristics of the crust and crumb for a given dough component or bread product of a given shape and size. While it is possible to select from a wide variety of formulations of dough components for a bread product, it is typical that compromises are accepted in terms of desired characteristics of crumb and crust in the preparation of a bread product. For example, if specific desired characteristics of the crumb are intended then it may be difficult or impossible to produce specific desired characteristics of the crust for the bread product. Likewise, it may be difficult to achieve with efficiency and consistency a desired combined characteristic or effect of crust and crumb in a bread product made of a monolithic dough component that is baked under identical operating conditions.

If the crust of the bread product is tasteful while the crumb is unappealing, the effort to produce a quality bread product is not a success. As is not uncommon, if the crumb of the bread product is appealing and tasteful but the crust of the bread product is not attractive or as appealing or tasteful, the effort to produce a quality bread product has still fallen short of the ideal. The ultimate result is likely to produce waste and inefficiency when the bread product is served and consumed (for example, the bread product when served may only be partially consumed by persons who eat the bread crumb but do not eat the bread crust and instead leave some or all of the crust behind on their plates as residual waste).

It is known to provide various treatments for the exterior surface of the dough component of a bread product before and during baking in an effort to alter the formation of the crust. It is also known to produce foodstuffs from layers of dough components. But such treatments and techniques are not understood in widespread implementation for commercially-produced multi-component bread products having one dough component for the crumb and another dough component for the crust.

There is identified an opportunity for an improved system and method of producing a multi-component baked bread product in which one selected dough component forms the interior crumb and another selected dough component provides the exterior surface that forms the crust of the baked bread component. There is identified an opportunity to produce such a bread product with such a system and method in a manner that is suitable for efficient high-volume commercial production. There is identified an opportunity for an improved multi-component baked bread product that provides a crust and crumb that can each be selected to exhibit desired characteristics (e.g. achieved through selection of their respective individual dough components) and that in combination are tasteful and appealing. There is identified an opportunity for an improved system and method to produce a variety of improved multi-component bread products efficiently with consistency and quality and in a variety of forms and types that each are tasteful and appealing to purchasers/consumers (e.g. more likely to be consumed in full, in all portions including the crust).

### SUMMARY

The present invention relates to a multi-component bread product for commercial production configured to be finished under operating conditions into a baked bread product having a crumb provided from a dough mass and a crust provided at an exterior layer. The bread product comprises a first dough component dispensed as the interior dough mass that will form the crumb of the bread product when the bread product is finished into a baked bread product and a second dough component applied to provide the exterior layer on the dough mass having an exposed surface at which the crust of the bread product will form when the bread product is finished into a baked product. The first dough component is formulated from a first set of ingredients and the second dough component is formulated from a second set of ingredients. When the bread product is finished into a baked bread product the operating conditions produce (a) in the interior dough mass a crumb having certain desired characteristics and (b) in the exterior layer a crust having certain desired characteristics.

The present invention also relates to a system to produce a multi-component bread product with an interior dough mass formed from a first dough component and an exterior layer formed from a second dough component. The system comprises (a) a mixing station configured to mix a first dough component from a first set of ingredients and to mix a second dough component from a second set of ingredients; (b) a forming station configured to form the bread product by dispensing the first dough component into the interior dough mass and applying the second dough component as the exterior layer onto the interior dough mass; (c) a finishing station configured to finish the bread product into a bread product for commercial distribution. When the bread product is baked into a baked bread product under operating conditions the interior dough mass will form the crumb of the baked bread product and the crust of the baked bread product will form at an external surface of the exterior layer applied to the dough mass. The first set of ingredients and the second set of ingredients are selected so that when the bread product is finished into baked bread under the operating conditions the crumb exhibits certain desired characteristics and the crust exhibits certain desired characteristics.

The present invention further relates to a method of producing a multi-component bread product for commercial distribution to be finished under operating conditions into a baked bread product. The method comprises the steps of: (a) mixing a first dough component from a first set of ingredients; (b) mixing a second dough component from a second set of ingredients; (c) forming the bread product by dispensing first dough component into an interior dough mass and depositing second dough component as an exterior layer onto the interior dough mass; (d) finishing the bread product into a finished bread product. The bread product is baked into a baked bread product under operating conditions. The interior dough mass will form the crumb of the baked bread product and the crust of the baked bread product will form at an external surface of the exterior layer applied to the dough mass. The first set of ingredients and the second set of ingredients can be selected so that when the bread product is finished into a baked bread product the operating conditions produce the crumb having certain desired characteristics and the crust having certain desired characteristics.

The present invention further relates to an apparatus configured to produce a multi-component bread product with an interior dough mass formed from a first dough component mixed from a first set of ingredients and an exterior layer formed from a second dough component mixed from a second set of ingredients. The apparatus comprises a dispenser to dispense the first dough component into the interior dough mass and a dispenser to apply the second dough component as the exterior layer onto the interior dough mass. When the bread product is baked into a baked bread product under operating conditions the interior dough mass will form the crumb of the baked bread product and the crust of the baked bread product will form at an external surface of the exterior layer applied to the dough mass. The first set of ingredients and the second set of ingredients are selected so that when the bread product is finished into baked bread under the operating conditions the crumb exhibits certain desired characteristics and the crust exhibits certain desired characteristics.

The summary is illustrative only and is not intended to be in any way limiting. In addition to the illustrative aspects, embodiments, and features described above, further aspects, embodiments, and features will become apparent by reference to the drawings and the following detailed description.

### FIGURES

FIG. 1 is a perspective view of a bread product according to an exemplary embodiment.

FIG. 2A is a cut-away perspective view of a bread product according to an exemplary embodiment.

FIGS. 2B-2C are schematic cross-section views of a bread product according to an exemplary embodiment.

FIGS. 3A-3B are cut-away perspective views of bread products according to an exemplary embodiment.

FIGS. 3C-3D are schematic cross-section views of a bread product according to an exemplary embodiment.

FIGS. 4A-4B are schematic cross-section views of a system for producing a bread product in operation according to an exemplary embodiment.

FIG. 5A is a schematic cross-section view of a system for producing a bread product in operation according to an exemplary embodiment.

FIG. 5B is a schematic top view of a system for producing a bread product in operation according to an exemplary embodiment.

FIGS. 6A-6B are schematic cross-section views of a system for producing a bread product in operation according to an exemplary embodiment.

FIG. 6C is a schematic top view of a system for producing a bread product in operation according to an exemplary embodiment.

FIGS. 6D-6E are schematic cross-section views of a system for producing a bread product in operation according to an exemplary embodiment.

FIGS. 7A-7B are schematic perspective views of a system for producing a bread product in operation according to an exemplary embodiment.

FIGS. 8A-8B are schematic cut-away perspective views of bread products of a type produced in the system of FIGS. 4A-4B.

FIG. 9 is a schematic cross-section view of a system for producing a bread product in operation according to an exemplary embodiment.

FIG. 10 is a schematic cross-section view of a system for producing a bread product in operation according to an exemplary embodiment.

FIG. 11 is a schematic cross-section view of a system for producing a bread product in operation according to an exemplary embodiment.

FIG. 12 is a schematic cross-section view of a system for producing a bread product in operation according to an exemplary embodiment.

FIG. 13A is a schematic block diagram of a system for producing a bread product according to an exemplary embodiment.

FIG. 13B is a schematic process flow diagram of a system for producing a bread product according to an exemplary embodiment.

FIG. 14 is a schematic process flow diagram of the mixing operation of the system for producing a bread product according to an exemplary embodiment.

FIGS. 15A-15B are schematic process flow diagrams of the forming operation of the system for producing a bread product according to an exemplary embodiment.

FIGS. 16A-16C are schematic process flow diagrams of the forming operation of the system for producing a bread product according to an exemplary embodiment.

FIGS. 17A-17C are schematic process flow diagrams of the finishing operation of the system for producing a bread product according to an exemplary embodiment.

FIG. 18 is a schematic process flow diagram of the packing operation of the system for producing a bread product according to an exemplary embodiment.

FIGS. 19A-19J are schematic cross-section views of a system for producing a bread product in operation according to an alternative embodiment.

FIG. 19K is a cut-away perspective view of a bread product of a type produced in the system of FIGS. 19A-19J.

FIG. 20A is a schematic cross-section diagram of an extrusion system for producing a bread product according to an exemplary embodiment.

FIG. 20B is a schematic cross-section view of a bread product of a type produced in the system of FIG. 20A.

FIG. 21 is a schematic cross-section diagram of an extrusion system for producing a bread product according to an exemplary embodiment.

FIG. 22 is a schematic cross-section diagram of an extrusion system for producing a bread product according to an exemplary embodiment.

FIGS. 23A-23D are schematic cross-section diagrams of an extrusion system for producing a bread product according to an exemplary embodiment.

FIGS. 23E-23F are schematic cross-section views of a bread product of a type produced in the system of FIGS. 23A-D.

FIG. 23G is a cut-away perspective view of a bread product of a type produced in the system of FIGS. 23A-23D.

FIGS. 24A-24B are schematic cross-section views of a bread product according to an alternative embodiment.

### DESCRIPTION

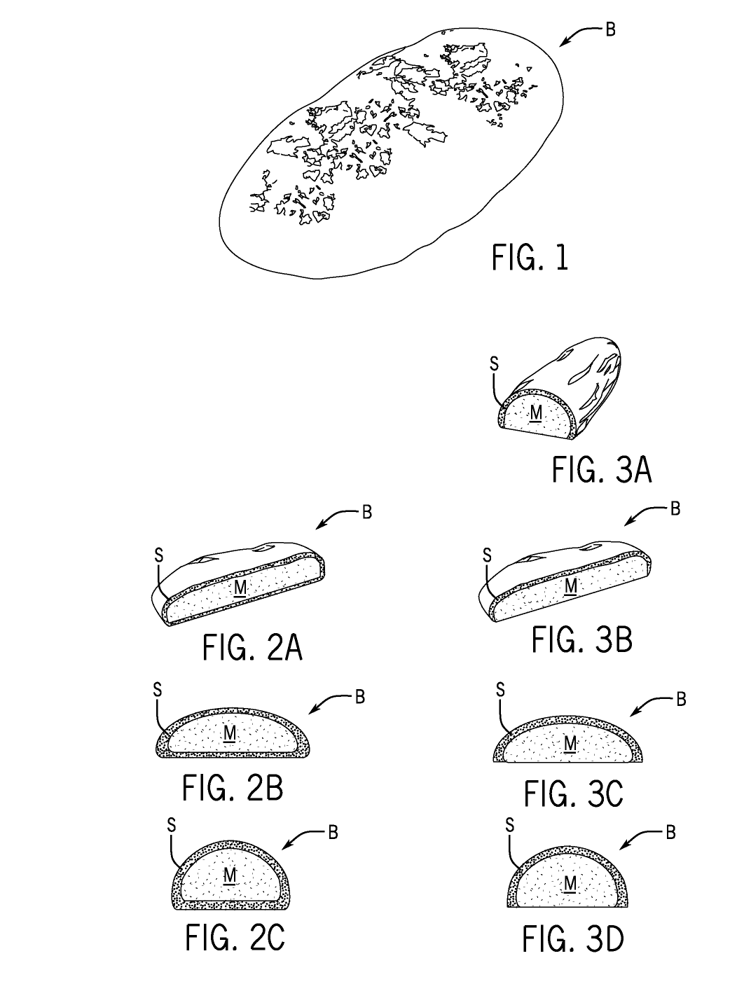

Referring to FIG. 1, a two-component baked bread product in the form of bread loaf B is shown. Baked bread loaf B comprises a central or interior portion or core shown as crumb M and an outer or exterior portion or layer shown as a crust S (e.g. a distinct surface effect formed at the exterior surface by the Malliard reaction at the time the bread product is baked). As shown in FIGS. 2A-2C, according to an exemplary embodiment, crust S may essentially encapsulate crumb M. As shown in FIGS. 3A-3D, according to another exemplary embodiment, crust S may cover all but the bottom surface of crumb M (e.g. crust formation depending upon how the bread product is formed and baked). Bread loaf B is formed from two dough components (e.g. two formulations or types of dough). Crumb M is formed from a first dough component (e.g. the core or inner/interior portion); crust S is formed at the exposed surface of a second dough component (e.g. the layer or outer/exterior portion). According to an exemplary embodiment, the first dough component (for the crumb) and the second dough component (for the crust) can be individually selected so that the baked bread product (e.g. baked bread loaf) is a multi-component bread product that has a crust and crumb combination with desired characteristics that otherwise may be difficult to achieve by conventional production methods (e.g. individual/combined crust-crumb properties difficult to achieve with a bread product formed of a single dough type or component).

According to a preferred embodiment, the first dough component and the second dough component (which typically will be baked simultaneously in identical operating conditions of temperature, time, humidity, air movement, etc. when the baked product is produced) can be independently selected so that each of the crust and the crumb independently will exhibit desired characteristics and the crust-crumb combination will produce a desired composite characteristic for the multi-component baked bread product. According to a preferred embodiment, the baked bread product will comprise a multi-component bread product formed of dough components that together provide a desired effect or characteristic, e.g. texture, consistency, flavor, aroma, color, shape, size, mass/density, shelf-life, etc. According to particularly preferred embodiments, for example, a bread product of a particular form may be produced with one type of base dough component for the crumb and multiple different available options for the dough component for the crust, each crust-crumb combination of which can be selected for a purpose achieved in the baked bread product (e.g. to suit tastes of customers, to produce desired aesthetic affects, to enhance shelf-life, or to obtain other desired effects or combinations of desired effects in the composite baked bread product). As indicated, the ability to independently select separate dough components for the crumb and the crust of a baked bread product allows for production of as many different types of bread products as there are corresponding different compatible crust-crumb combinations available (e.g. through different combinations of dough components). According to exemplary and other embodiments, the system and method allows the selection of the respective dough components for the base and layer to be based on considerations and preferences of the persons who are designing or producing the bread product (and such persons may have widely-varying intent, tastes and preferences for the characteristics to be exhibited).

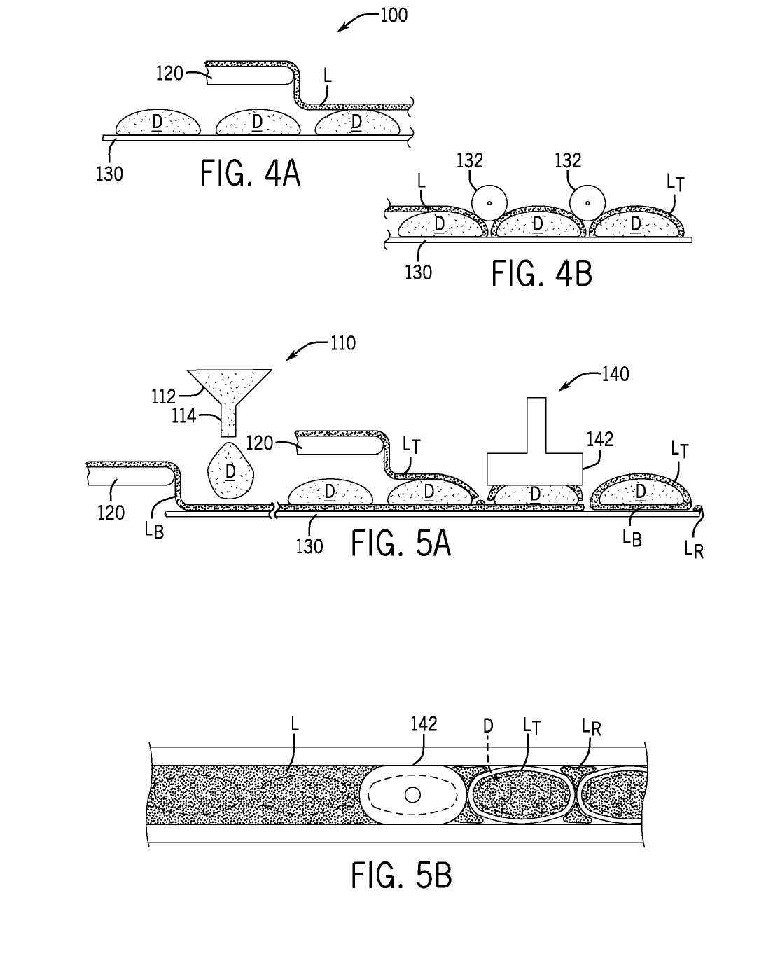

It is generally known to form a multi-layer effect in a dough-based product with application of a sheet layer or laminate. Such known principles are adapted and applied according to exemplary embodiments of the system and method for producing a bread product. For example, as shown representationally in FIGS. 4A-4B, 4A-5B, 7A-7B and 9, systems and methods to produce a bread product according to exemplary embodiments can be adapted from known configurations, such as disclosed in U.S. Pat. No. 3,851,088, U.S. Pat. No. 4,907,501, U.S. Pat. No. 2,627,822, European Patent No. 1,720,414 and U.S. Published Patent Application No. 2003/0203094.

Referring to FIGS. 4A and 4B, a schematic diagram of a system 100 for producing a bread product of the type shown in FIGS. 3A-3D is shown according to exemplary embodiment. As shown schematically in FIG. 4A, a dough base shown as dough ball D formed of a first dough component are deposited on a conveyor shown as belt 130 and transported to a station where a layer L formed as a sheet of a second dough component is deposited from a dispenser 120 to cover the dough ball D. As shown in FIG. 4B, an apparatus shown as comprising rollers 132 operates to help adhere the layer L to the surface of dough ball D. When the bread product of the dough ball D and of layer L is baked (as indicated in FIGS. 3A-D) baked bread product B will have the dough ball D (of FIGS. 4A-B) to substantially comprise the crumb M (e.g. FIGS. 3A-D) and the exterior of layer L (of FIGS. 4A-B) to substantially comprise the crust S (e.g. FIGS. 3A-3D) of the baked bread product B.

Referring to FIGS. 5A and 5B, schematic diagrams of a system for producing a bread product of the type shown in FIGS. 2A-2C is shown according to an exemplary embodiment. As shown schematically in FIG. 5A, a bottom layer L_{B} formed of a dough component is deposited from a dispenser 120 as a sheet on a conveyor shown as belt 130. A dough ball D formed of a dough component is deposited from an outlet 114 of a vat 112 for a dispenser 110 onto sheet layer L_{B} on belt 130. A top layer L_{T} formed of a dough component is deposited from a dispenser 120 as a sheet to cover over the dough ball D. An apparatus shown as a forming or stamping tool 140 operates to compress and adhere layer L_{T} over the top and sides of the surface of dough ball D and to compress and adhere layer L_{B} at the bottom surface of dough ball D as to form a bread product that has a dough ball (of a dough component) encapsulated between a top layer (of a dough component) and a bottom layer (of a dough component). According to an exemplary embodiment, the top layer and the bottom layer may each be of the same dough component; the top layer and the bottom layer may be substantially the same thickness. According to other exemplary and alternative embodiments, the top layer may be of a different dough component than the bottom layer; the top layer may be of a different thickness than the bottom layer.

According to an exemplary embodiment, shown schematically in FIGS. 5A and 5B, the forming or stamping tool 140 will have a tool or head 142 configured to operate in a reciprocating (up/down) action to form the bread product comprising dough ball D with top layer L_{T} and bottom layer L_{B} into a designed shape (shown as generally oval in profile). When the bread product of dough ball D and top layer L_{T} and bottom layer L_{B} is baked, as indicated in FIGS. 2A-2C, in the baked bread product B the dough ball D (of FIGS. 5A-B) will substantially comprise the crumb M (of FIGS. 2A-2C); the exterior surface of the top layer L_{T} and the exterior surface of the bottom layer L_{B} (of FIGS. 5A-5B) will together substantially comprise crust S (of FIGS. 2A-2C). As indicated in FIGS. 5A and 5B, residual dough component layer L_{R} from bottom layer L_{B} and/or top layer L_{T} after application and/or encapsulation of the dough ball (e.g. residual material not adhered to or encapsulating the dough ball) can be recovered and reused (e.g. re-mixed with the residual material mixed into the dough component for the layer). As indicated, the forming tool may be configured to produce a bread product having any of a variety of forms and shapes according to other exemplary embodiments.

According to an exemplary embodiment, the dough component may be allowed a period of time to proof (e.g. ferment or leaven) prior to being dispensed for application or encapsulation with the layer. As indicated schematically in FIG. 5A, after the dough base is dispensed, a period of time (of pause or delay) may be allowed for proofing prior to application of the layer as part of the operation of the system and method.

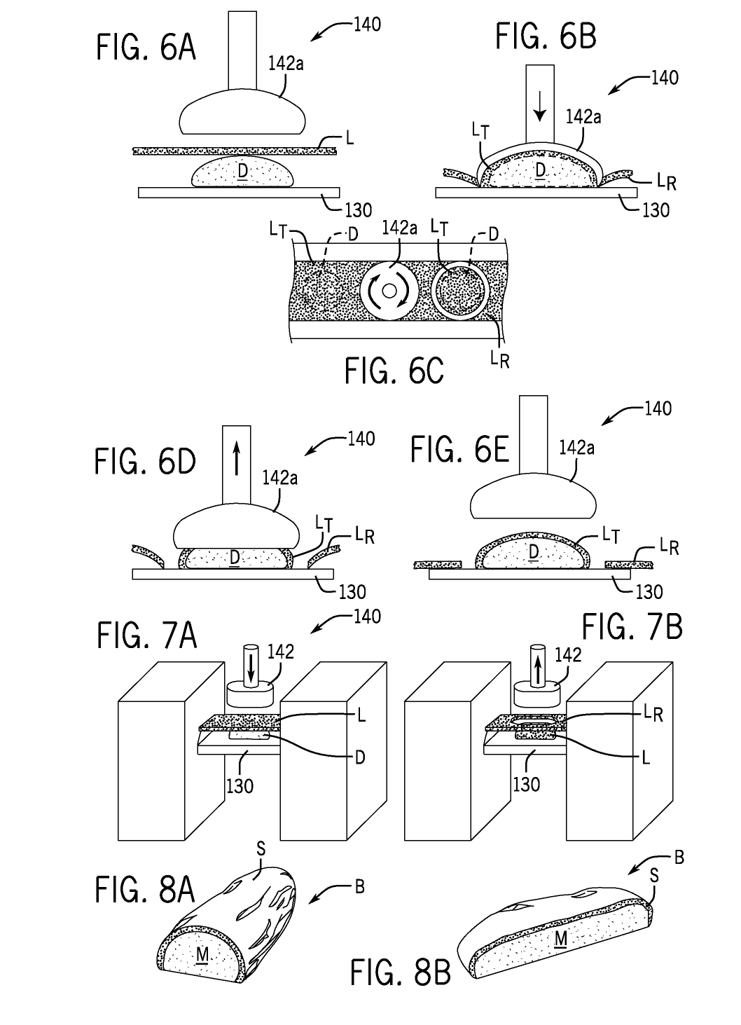

As shown schematically in FIGS. 6A-6E, the forming or stamping tool 140 can have a mechanism such as a circular head 142a that has edges configured in a claw-shaped form to develop a cutting and shaping action when applied to compress and adhere the layer L_{T} to the dough base D. As shown in FIG. 6C, the head 142a of tool 140 may be configured to rotate to separate or detach the portion shown as layer L_{T} to attach the surface of dough ball D from the residual portion shown as layer L_{R} (e.g. recoverable for recycle/reuse after the forming operation). As shown in FIGS. 6D-6E, when tool 140 is retracted the head 142a is lifted from the formed two-component bread product (shown as circular in profile) in which the surface of the dough ball D has been encapsulated or covered by the layer; the formed multi-component bread product can be conveyed for further processing at other stations (e.g. a station for baking or par-baking and/or freezing).

As indicated schematically in FIGS. 7A-7B and 10A, the forming station (e.g. forming or stamping tool) can be installed as part of a production line between other stations or operations at a facility (e.g. with a mixing station before the forming station and a baking oven/finishing station and packing station after the forming station) to produce bread product or bread products in a batch or in a substantially continuous flow operation suitable for efficient high volume production. As also indicated, according to alternative embodiments, the forming station may comprise a forming or stamping tool with (or that is configured with) other apparatus or capabilities/fixtures (e.g. a mechanism in the head for gripping or shaping the bread product, a cooling or heating element to “set” or par-bake the bread product, etc.). According to another exemplary embodiment, the forming station may include an integrated dispenser configured to apply the (top) layer of dough component (e.g. as a sheet) or to deposit a liquid dough component (e.g. batter) to form as a layer adhered to the top and sides of the dough ball.

According to any preferred embodiment, the forming station/apparatus is configured to apply a dough component (layer) that will provide the exterior surface to become the crust of a baked bread product to a dough component (dough base or dough ball) that will become the crumb of the baked bread product in a suitable manner as to form a two-component baked bread product when baked that exhibits a desired characteristic or set of characteristics of crust-crumb combination (see FIGS. 2A-2C, 3A-3D and 8A-8B). As indicated, according to exemplary embodiments the form of the dough base or dough ball may be produced in any of a wide variety of shapes and sizes with the accompanying layer conformed to the shape and size of the dough base or dough ball.

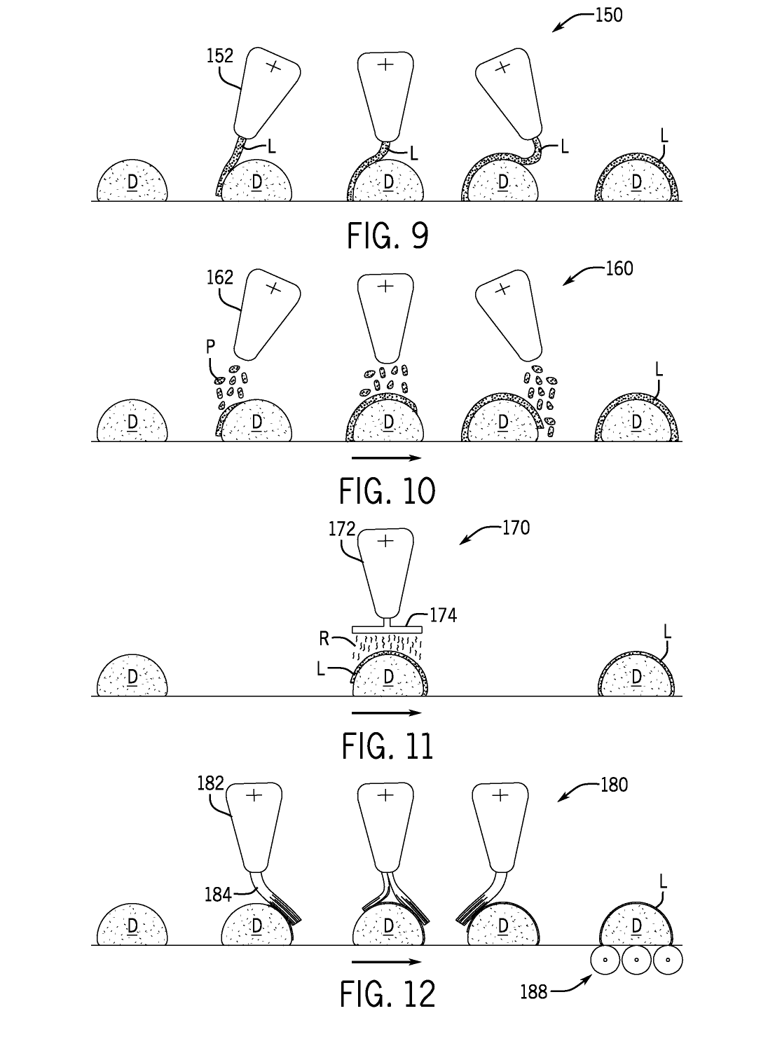

As indicated schematically in FIGS. 9 through 12, the dough component of the top layer L_{T} (providing an exterior surface that will form the crust of the baked bread product) can be applied to the surface of the dough base D (e.g. that will substantially form the crumb of the baked bread product) in a variety of different types of stations that may employ various other methods and apparatus according to exemplary and alternative embodiments. As shown in FIG. 9, the station 150 comprises a dispenser 152 that applies as a sheet a dough component shown as layer L across the top and to drape over and along the sides of the surface of the dough ball D. As shown in FIG. 10, the station 160 comprises a dispenser 162 that applies a dough component in a semi-liquid/semi-solid form of globules or particulates P in a sputtering process to deposit a layer L onto the top and side surface of the of dough ball D. As shown in FIG. 11, the station 170 comprises a dispenser 172 that applies a dough component in a liquid (e.g. suspension or batter) form as a spray R from a spray head 174 (which can be arranged individually or in an array of multiple spray heads) as layer L onto the exposed surface of the dough ball D. As shown in FIG. 12, the station 180 comprises a dispenser 182 that applies a dough component in a liquid (e.g. suspension or batter) form Q as a layer L across the top and side surface of the dough ball D by a brush 184; as also shown according to an alternative embodiment, the station may be configured to apply the supply of dough component as liquid/batter Q as a layer L on the bottom or underside of dough ball D by an apparatus shown as roller brush system 188 (or a spray head array or other apparatus).

As shown schematically in FIGS. 6 through 12, according to exemplary embodiments, a station may be configured to apply a layer that is comprised of any of a variety of components (e.g. mixed ingredients or formulation/recipe) and/or of any of a wide variety of thicknesses so as to produce a resultant baked bread product intended to provide a resultant desired crust. As indicated, according to alternative embodiments, the bread product may be produced in a multi-step or multi-station operation so that the multi-component bread product will have multiple applications or layers of dough component (or other treatments) deposited on the dough ball, for example, to produce a multi-layer effect as shown in FIGS. 24A-24B. As indicated, by the example configurations of the stations of FIGS. 9 and 10, a relatively thicker layer/component may be deposited on the surface of the dough ball (in comparison to a mean); as indicated by the stations of FIGS. 11 and 12, a relatively thinner layer/component may be deposited on the surface of the dough ball (in comparison). According to other exemplary embodiments, stations shown in FIGS. 5A-12 may be combined in a sequence to apply the layer as a composite built up in steps or to form a multi-layer bread product.

As indicated for example in FIGS. 9-12, according to other alternative embodiments, the dough component of the layer could be applied (or built up) in an operation of multiple steps and/or by multiple tools or stations (or at a single station with multiple tools). The operation may include application of a treatment or pre-treatment such as a batter or other liquid to promote adhesion of the applied top layer of more solid dough component; the sequence of operation could be configured so that a base layer is applied to the dough ball as a spray and a top layer is a sheet over the base layer or substance. As shown in FIGS. 24A-24B, according to an alternative embodiment, a bread product having a core base (dough component D) and multiple layers (shown as outer layer L_{O} and inner layer L_{I}) could be created; when baked the corresponding baked bread product may have a crumb M and a crust S (shown as on the surface of outer layer L_{O} which with inner layer L_{I} may provide an effect such as enhanced flakiness or better adhesion or supplemental flavoring, etc.) (see FIG. 24B). According to another alternative embodiment, the dough component for the layer (e.g. a sheet) may be rolled or wrapped around the dough base or dough ball by a forming operation. As indicated, other variations of applying a layer to the dough base or dough ball may be configured according to alternative embodiments of the system and method.

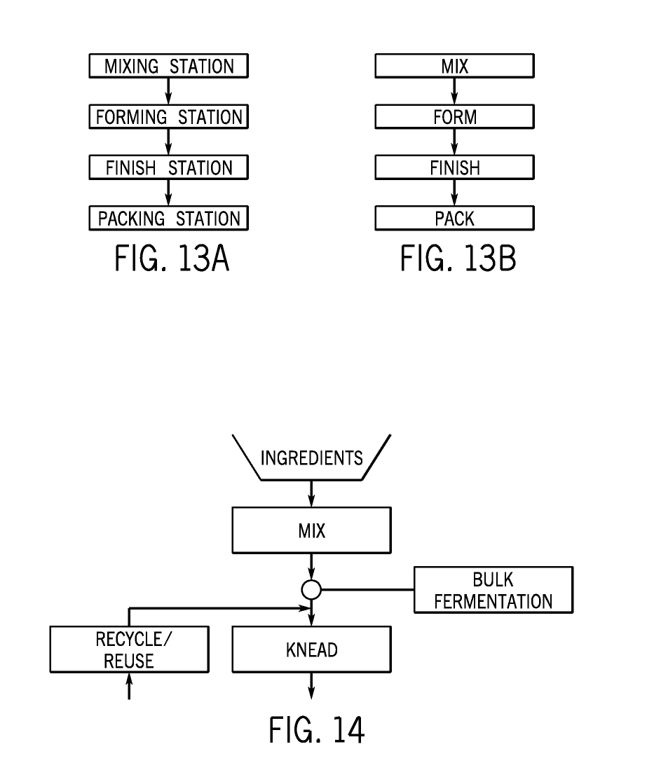

Referring to FIGS. 13A-13B, a system and method of producing a bread product of a type shown in FIGS. 1, 2A-2C and 3A-3D is shown according to exemplary and alternative embodiments. As shown in FIGS. 13A-13B, the system comprises a mixing station to mix ingredients for the dough component, a forming station to form the dough base or dough ball with layer into the two-component based product (ready to be baked), a finishing station to finish the bread product into form for commercial use and/or consumption (e.g. baking or par-baking and/or freezing depending on the next intended use), and a packing station to pack the bread product as to facilitate commercial use and/or consumption (e.g. packaging the baked/par-baked bread product into packaging materials with labels and inspected for shipment and sale).

The operation of the mixing station is shown according to an exemplary embodiment in FIG. 14. As shown, ingredients for the dough components of the bread product are assembled and mixed (and allowed time for bulk fermentation if required, desired or suitable); each resultant dough component is worked and conditioned and maintained according to the respective recipe or formulation (e.g. by kneading or further mixing) and then dispensed at the forming station. Residual dough component from the forming station (e.g. residual portions of the sheet layer or residual matter from deposition of the layer material) can optionally be reused or recycled by recombination and re-mixing to supplement the dough component created by mixing of new/fresh ingredients.

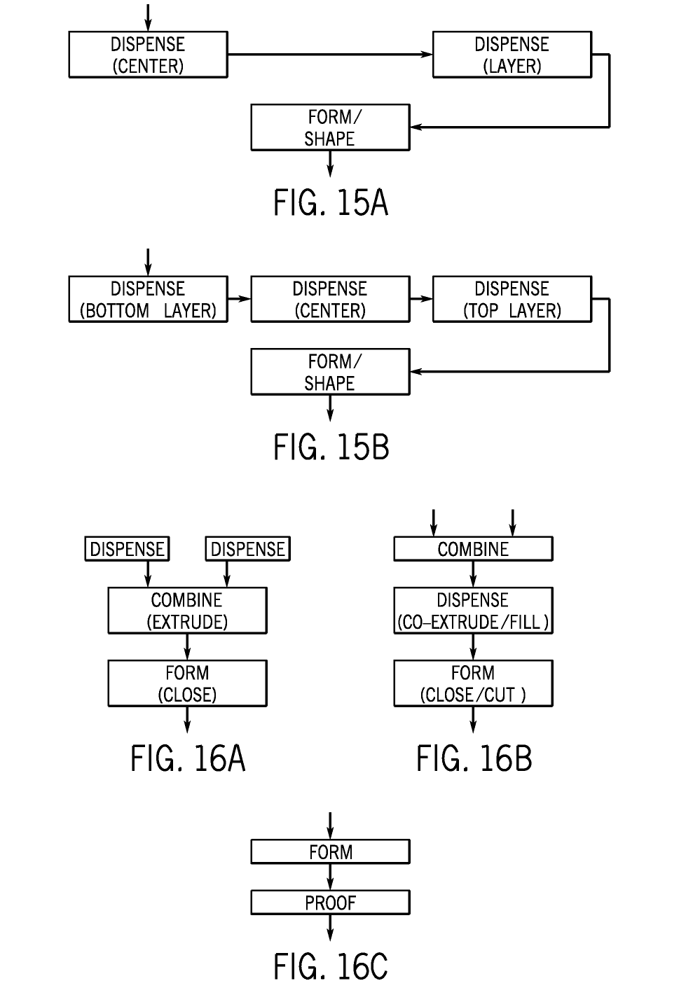

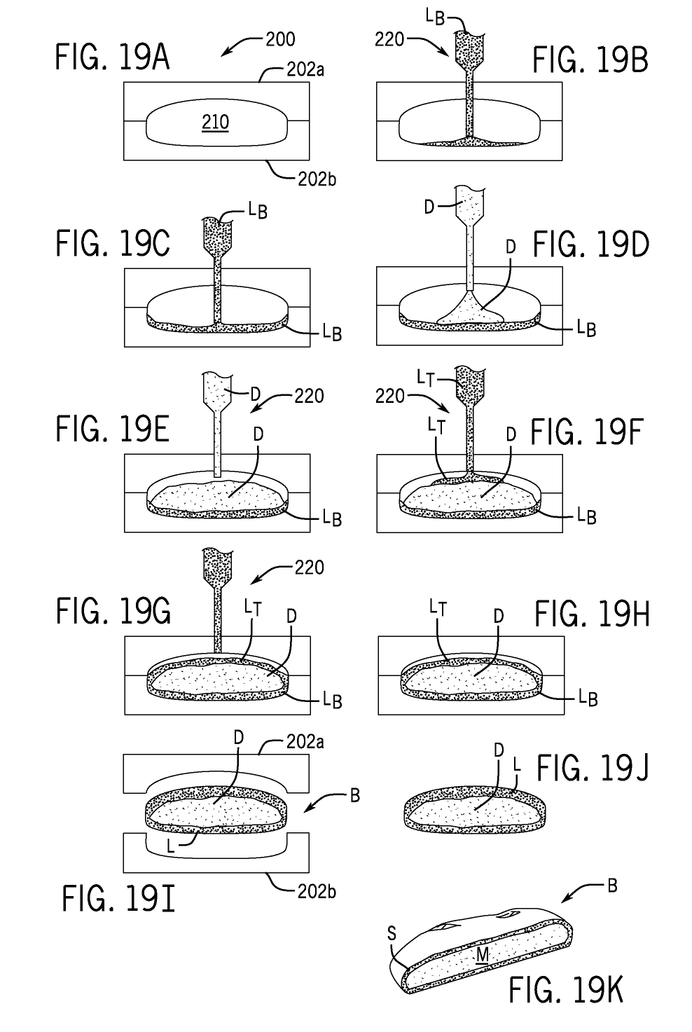

The operation of the forming station is shown schematically in FIGS. 15A through 16C according to exemplary and alternative embodiments. As shown in FIG. 15A, for a bread product of a type shown (for example) in FIGS. 3A-3D and FIGS. 4A-4B, 6A-6E and 9-12 (for example) with a top layer on the dough base or dough ball, the dough component for the dough base or dough ball of the center of the bread product is dispensed and then the dough component for the layer is dispensed; the two-component bread product is formed upon application of the layer to the base as shown (for example in FIGS. 4A-4B, 5A-5B, 6A-6E, 7A-7B and 9-12). As shown in FIG. 15B, for a bread product of a type shown (for example) in FIGS. 4A-4B and 6A-6E). As shown in FIG. 15B, for a bread product of the type shown (for example) in FIGS. 2A-2C, FIGS. 5A-5B and FIGS. 19A-19K with an inner (interior) dough base encapsulated between or within the outer (exterior) layer, the dough component for the under or bottom layer is dispensed and then the dough component for the center forming the dough base is dispersed and then the dough component for the upper or top layer is dispensed; the multi-component bread product is formed upon completion of deposition of the top layer (for example as shown in FIGS. 19A-K or by additional steps or operations as in FIGS. 5A-5B).

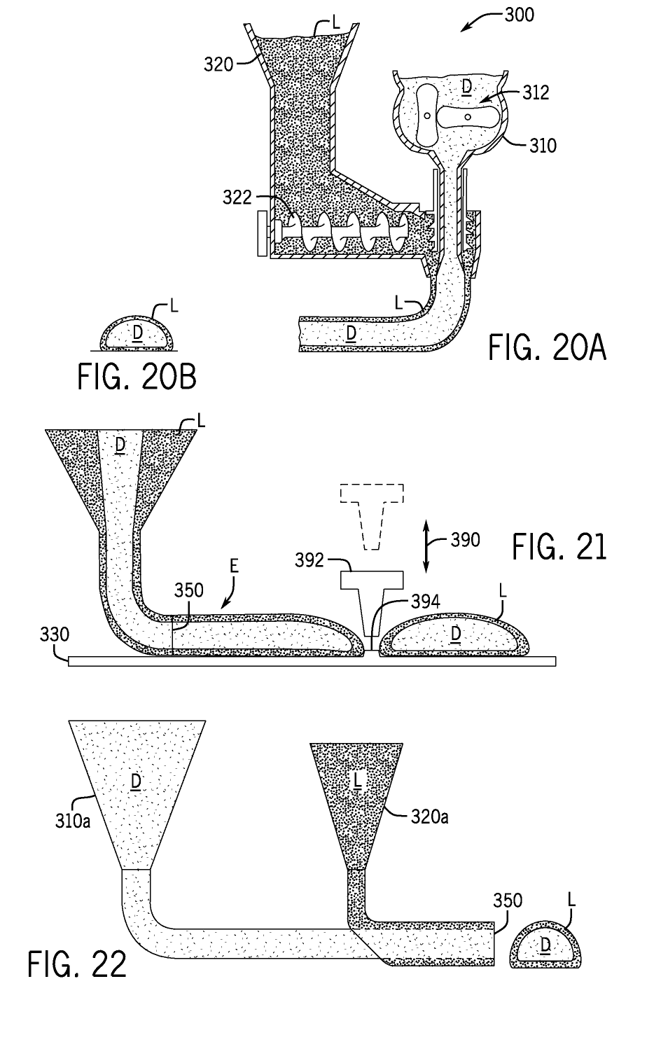

The operation of a forming station is shown in FIGS. 16A-16B according to alternative embodiments. As shown in FIGS. 16A-16B, multi-component bread product of the type indicated in FIGS. 20A-23F can be produced by extrusion or co-extrusion of separately mixed and dispensed dough components for the layer and the center or base. FIG. 16A shows schematically an extrusion process for a two-component baked bread product in which the dough component for the center is extruded through an outlet and then the dough component for the layer is extruded through an outlet and applied onto the dough component for the center (see FIG. 22). FIG. 16B shows schematically a co-extrusion process for a two-component bread product in which the dough components for the center (base) and the layer are substantially simultaneously co-extruded to form the two-component bread product at the outlet (see FIGS. 20A and 21). The two-component extruded bread product then can be formed to a desired size (e.g. cut) and/or shaped to a desired form (e.g. by a tool) so that the bread product is ready for the finishing operation and other operations.

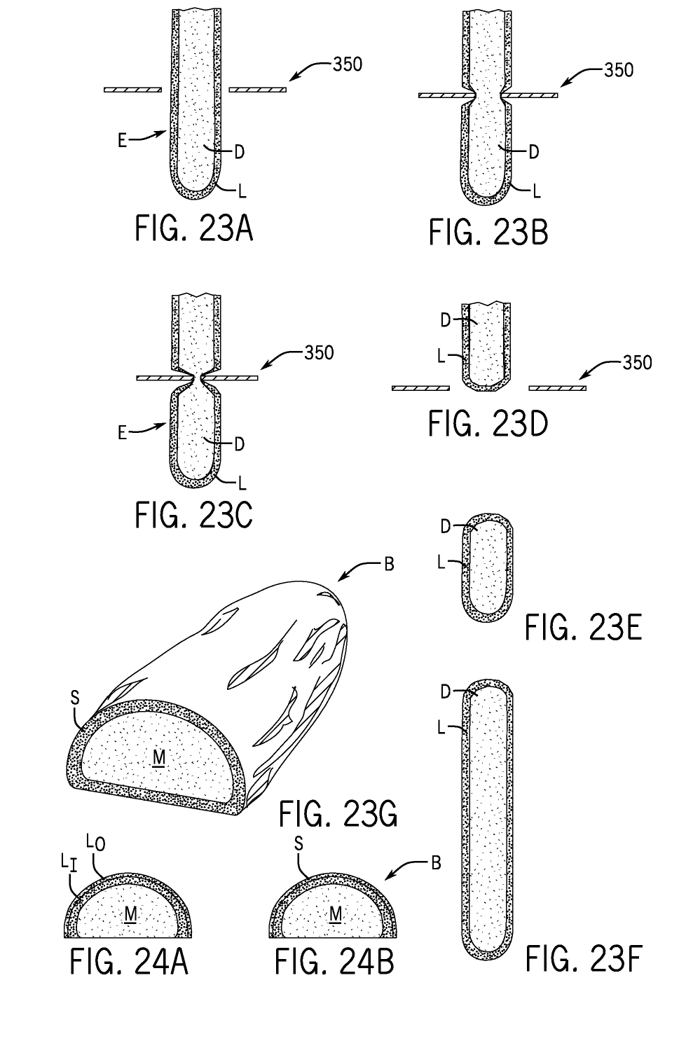

According to alternative embodiments, the forming operation may comprise other steps such as proofing (e.g. allowing the dough product to leaven/rise, see FIG. 16C) and/or the application of a thermal effect (e.g. heating or par-baking and/or cooling or freezing or ends of the product) to “set” all or some portion of the bread product to hold the desired form or closure at the end (e.g. FIGS. 23A-23F). According to exemplary embodiments, the dough component of the core or base may be “set” by other process operations or techniques to achieve the desired objective (e.g. heated or cooled by use of a thermal element, heated by microwave techniques or infrared, heated by par-baking, etc.) such as to retard or halt leavening prior to the application of the layer or to facilitate adherence of the layer to the surface of the dough base. According to other exemplary embodiments, a surface treatment (e.g. a batter or other/liquid composition to serve the treatment function) may be applied to the surface of the dough base or dough ball before the layer to facilitate adhesion of the dough layer (see, e.g., FIGS. 11 and 12).

According to an exemplary embodiment, the system including the forming station may be configured so that a variety of different forms and types of bread products can be produced at the production facility. The apparatus employed in the forming station (e.g. as shown schematically in FIGS. 5A-5B, 6A-6E, 7A-7B, 9-12 and 19A-19I) may comprise modular or interchangeable tooling/fixtures so that the system can be reconfigured and modified by interchanging tooling/fixtures to produce multiple different types of bread products with various different shapes, forms, sizes and layering or layers/layer effects at the forming station. As indicated, for example, one forming tool may be used at the forming station to produce a bread product having one form and another forming tool may be used at the forming station to produce a bread product having another form (see FIGS. 5A-5B); one mold fixture may be used at the forming station to produce a bread product having one form and another mold fixture may be used at the forming station to produce a bread product having another form (see FIGS. 19A-19I); one bread product may be formed by having the outer layer deposited as a sheet and another bread product may be formed by having the outer layer deposited by spray or sputtering (see FIGS. 9-12).

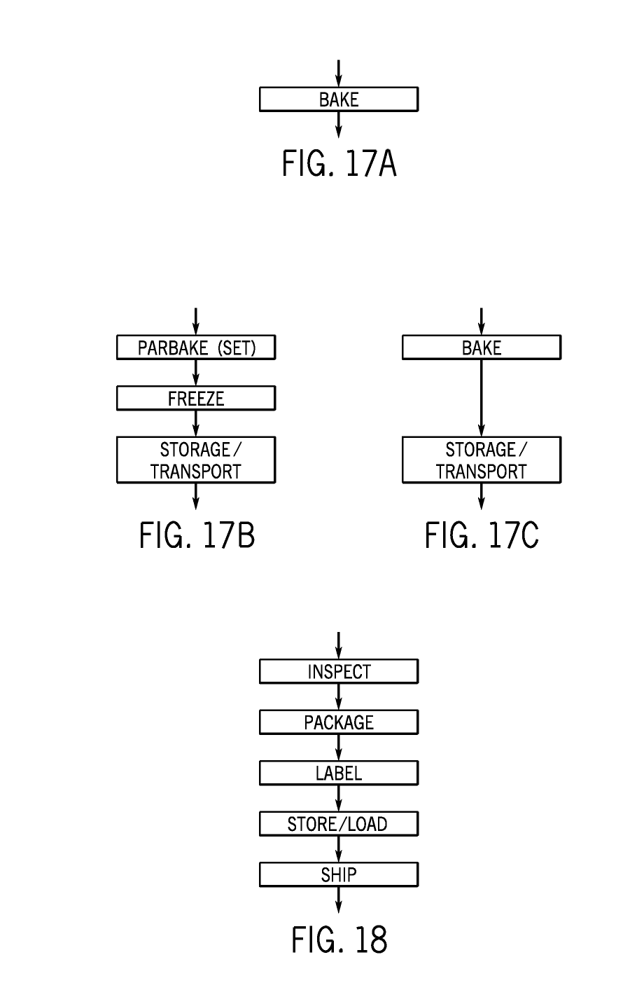

The operation of a finishing station is shown schematically in FIGS. 17A-17C according to exemplary embodiments. As shown in FIG. 17A, the multi-component bread product with layer L and center D can be baked and then made packaged or alternatively available for sale and/or consumption at the facility (e.g. as if at a bakery). As shown in FIGS. 17B-17C, the bread product may be finished into a form for commercial transport/delivery (e.g. by truck, train etc.) and stocking/sale (e.g. at a warehouse, storage, store, supermarket, retail outlet, restaurant, eatery, cafeteria, etc.) The bread product may be par-baked (set in form) and then frozen and stored and transported (see FIG. 17B) or the bread product may be baked and readied to be stored and transported (see FIG. 17C).

The operation of a packing station to prepare the product for commercial distribution is shown schematically in FIG. 18 according to an exemplary embodiment. As shown, in the final steps of preparing the par-baked or baked product for shipment, additional steps may include inspection of the product (e.g. visual, x-ray, photographic, etc.), packaging the product in a package (e.g. in bag, box, etc.), labeling the package, storing and loading the product to be shipped/transported for next use.

According to exemplary and other embodiments, the system and method can be adapted (in whole or in part or parts) to be incorporated in improvements of any of a wide variety of known/conventional and other production systems and methods currently in use in the production of bread products. For example, apparatus of the system and method (e.g. including any fixture/tool or station as shown in the FIGURES) may be adapted and/or installed and included in improvements of existing/in-use or future-developed systems and methods of manufacturing bread products so that such bread products may be produced in an improved form and manner (e.g. including any bread product as shown in the FIGURES) according to exemplary and other embodiments. According to an exemplary embodiment, an existing or future system and method for producing bread products may be adapted and modified/improved to include an apparatus to deposit or form a layer on a dough base to produce a multi-component bread product that when baked has a crumb formed of one dough component (from the dough base) and a crust formed at the surface of another dough component (at the exterior of the layer).

As shown schematically in FIGS. 19A-J, according to an alternative embodiment a sequence of steps can be employed to form a multi-component bread product in a mold or fixture that will have a form as shown in FIG. 19K. It is generally known to form multi-component foodstuffs in a mold fixture in which the components are injected. Such known principles are adapted and applied according to exemplary embodiments of the system and method to produce a multi-component bread product. For example, as shown representationally in FIGS. 19A-19J, systems and methods to produce a bread product according to exemplary embodiments can be adapted from known configurations, such as disclosed in U.S. Pat. No. 8,124,156. As shown, mold 200 has a section 202a and a section 202b that are closed and sealed together to create a cavity 210 (see FIGS. 19A-19C). Dough component for a bottom layer L_{B} is dispensed into the cavity from a dispenser dough component for a dough center D and is then dispensed into the cavity atop bottom layer L_{B} from dispenser 200 (see FIGS. 19D-19E). Dough component for a top layer L_{T} is then dispensed into the cavity atop dough center D (see FIGS. 19F-19G). The bread product may be removed from the mold by separation of the mold sections (see FIG. 191). As indicated, each dough component is liquefied sufficiently (e.g. as diluted into a batter) to facilitate flow into the cavity of the mold or fixture. The bread product may be allowed a period of time to proof (leaven or rise) while inside the mold (or outside the mold). The bread product may be baked or par-baked (set to form/shape) while inside the mold; according to another alternative embodiment, the bread product may be removed from the mold before being baked or par-baked (set to form/shape). According to a preferred embodiment, the baked bread product B will have a crumb M from the dough component of the center dough portion D, and crust S formed (in part) by the dough component of the top layer L_{T} and (in part) by the dough component of the bottom layer L_{B}. See FIG. 19K.

Referring to FIGS. 16A-16B and 20A-23F, a multi-component bread product may be formed from an extrusion process according to alternative embodiments. It is generally known to employ extrusion processes for producing multi-component foodstuffs (including from a dough components). Such known principles are adapted and applied according to exemplary embodiments of the system and method of producing a multi-component bread product. For example, as shown representationally in FIGS. 20A-23D, systems and methods to produce a bread product according to exemplary embodiments can be adapted from known configurations, such as disclosed in U.S. Pat. No. 4,786,243, U.S. Pat. No. 4,882,185, U.S. Pat. No. 4,251,201, U.S. Pat. No. 4,698,000, U.S. Pat. No. 4,469,475, U.S. Pat. No. 4,266,920, etc. Referring to FIG. 20A, according to an exemplary embodiment (shown schematically) an apparatus shown as co-extrusion system 300 mixes and dispenses each dough component of the multi-component bread product. Co-extrusion system 300 comprises a vessel shown as mixing vat 310 with rotary mixing feeder arms 312 for the dough component for the center portion D of the bread product and a vessel shown as vat 320 with a generally cylindrical rotary screw feeder 322 for the dough component for the outer layer L of the bread product.

As shown schematically in FIG. 20A, dough component L is mixed (from ingredients) dispensed from vat 320 into a generally annular outlet passage around the passage for dough component D mixed (from ingredients) and dispensed from vat 310 to a common passage and outlet; at the end of the passage dough component L is no longer separated from dough component D and a co-extruded form of bread product in which dough component L is applied around dough component D and is dispensed at the outlet of the co-extrusion system 300. As shown schematically in cross-section in FIG. 20B, the bread product will have the dough component for the outer layer L encompassing the dough component for the center portion D of the co-extruded multi-component bread product. As shown in FIG. 21, a co-extrusion system 300x may use a forming tool 392 (shown schematically) operating in a reciprocating cutting action at a specified interval to segment the co-extruded form into bread products of specified or intended lengths. An extrusion system 300e having a vat 310a for dough component D and vat 320a for dough component L is shown schematically in FIG. 22. As indicated, the streams of the dough components for the center portion D and the layer L can be dispensed and then combined into the desired form of the multi-component extruded product. See FIG. 13A.

As indicated schematically in FIGS. 23A-23F, the extruded multi-component bread product can be selectively cut to length and formed at the respective ends by a mechanism comprising gate 350. The extended multi-component bread product cut to length is then finished, for example, baked to produce a baked co-extruded multi-component bread product B having a crust S (corresponding to dough component of layer L) and a crumb M (corresponding to dough component of center portion D as shown in FIG. 23G).

According to other exemplary embodiments, the co-extrusion system or extrusion system may be of any type suitable for formation and handling of a multi-component bread product. As indicated, sizing and arrangement and configuration of the elements of the system can be adapted/modified or adjusted to form set bread products that have a desired overall shape and proportion and a desired thickness of the dough component for the layer applied to the dough component for the center portion as desired or designed for the purpose or requirements. According to any preferred embodiment, the ingredients for each dough component of the multi-component bread product may be selected and formulated so that the baked bread product exhibits desired characteristics of crust and crumb (as well as properties to facilitate the forming and finishing operations).

Ingredients for each dough component of the multi-component bread product may be formulated as suitable for the types of bread product as well as culinary considerations (of taste, texture, color, etc.) and to facilitate the efficient operations of forming process. According to exemplary embodiments, the operations of the forming process may be adapted for suitability to the dough components of the bread product; for example, a thick layer of dough component intended for a bread product to form a relatively thick crust may be applied to a dough base in a system such as shown in FIG. 9 (sheet layer dispenser); a thin layer of dough component intended for a bread product to form a relatively thin crust may be formed and applied to a dough base in a system such as shown in FIG. 11 or 12 (spray deposition or brush application of a liquid batter).

According to a preferred embodiment, the layer providing the exterior surface forming the crust will be of a thickness in a range between approximately 1 and 3 mm. According to any preferred embodiment, the layer forming the crust will be formulated to produce an intended effect and result in terms of the characteristics of the crust upon baking (e.g. through the Malliard reaction or other effect). As indicated, according to other exemplary embodiments, the thickness of the crust, and the intended effect achieved through the Malliard reaction (or other reaction or effect), the formulation of the dough composition for the layer can be modified or adapted over a wide range of types, shapes, tastes, purposes, etc. of bread products. As also indicated, the crust may form at or through some or all of the layer depending upon the thickness of the layer and the operating conditions of baking (e.g. temperature, time, humidity, air movement, etc.) as well as upon the formulation of the dough component for the layer (e.g. the crust may form only at an outer surface but not entirely through the entire layer).

Dough components may also be selected and combined by other characteristics intended to facilitate the forming operation (such as viscosity, flow-ability, density, adhesion, etc.). Operating conditions for baking or par-baking in the finishing operation (e.g. temperature, time, humidity, air movement, etc.) may also be adjusted or adapted to facilitate or establish characteristics of the dough components (e.g. to facilitate adhesion of the layer to the surface of the dough ball). Surface treatments or other preparations may be employed at or upon the interface of the dough base to the layer to facilitate the forming process (e.g. other ingredients may be applied to the surface of the dough base before deposition of the dough component for the layer).

### Example Formulations of Dough Components

Specific formulations of the dough component (or dough components) for a bread product according to exemplary embodiments, can be determined by the type of bread product intended to be produced and desired characteristics intended to be obtained in the bread product. According to any exemplary embodiment, formulations of a dough component may be adjusted or adapted for particular purposes as determined by the situation or need. As also understood to those of skill in the art, independent of the specific formulations of the dough components, other factors can affect the texture or flavor of a baked bread product, for example, mixing techniques, fermentation time, and the operating conditions of the baking/cooking procedure. According to any preferred embodiment, each dough component may be formulated to produce desired effects in the baked bread product, such as flavor, aroma, texture, consistency, color, shape, size, mass/density, shelf-life, etc.

Formulations for the dough components are expressed (by weight) in what is called a “baker's percentage” where the flour (or type of flour) that makes up the bulk of the formula is expressed as 100 percent (one unit) and all other ingredients are scale-based (by weight) on the unit of flour of the formulation of the dough component. As an example, a formulation for a baguette may be expressed as shown in TABLE 1. As indicated, the percentages of each ingredient may be adjusted within ranges and to suit the operating conditions for baking the bread product; suitable substitutions may also be employed for certain ingredients as or if necessary or appropriate.

Flour and water with a suitable amount of salt mixed to a suitable consistency will generally formulate a dough component suitable to produce bread products using the processes outlined in the exemplary embodiments. Other functional ingredient such as improvers and additives and garnishes, etc., may also be included in the formulation of the dough component for a bread product. Prehydrated starches and flours and flavorful liquids (instead of water) could be used according to other exemplary embodiments of a dough composition. According to any preferred embodiment, the dough component will be formulated to withstand the processes while yielding a baked bread product that is flavorful and functional for the intended purpose.

Other tools and techniques could be employed to affect and alter the flavor and texture of the end (baked) bread product made from the dough components. For example, according to exemplary embodiments, part of the mix of ingredients of the dough components could be pre-gelatinized; additives and garnishes (e.g. nuts, cheese, dry fruit, etc.) could be used; other known means for adjusting or improving the blend of flour and ingredients in a dough component could be used. As known to those of skill in the art, there are a wide range of ingredients and options for formulating a suitable dough component or dough components; no suitable formulation of dough component for a bread product is intended to be excluded according to the exemplary embodiments.

### Example A

To provide a rich or dense enriched dough component for the dough component (to which the outer layer would be applied) as the crust of the baked bread product an example formulation may comprise the formulation shown in TABLE 2.

As indicated, the percentages of each ingredient may be adjusted within ranges and to suit the operating conditions for baking the bread product; suitable substitutions may also be employed for certain ingredients as or if necessary or appropriate.

### Example B

Composition of batter (liquid) that could be deposited into a mold to form the baked bread product may be formulated from ingredients. A composition or formulation of a batter or slurry that could be applied to the dough (e.g. by spray or sputtering or brush or rollers, etc.) may comprise flour 100 percent and water 500 percent.

According to other exemplary embodiments, the variation of proportion of water to flour may be adjusted according to the apparatus and operating conditions for the process/procedure.

As indicated, the percentages of each ingredient may be adjusted within ranges and to suit the operating conditions for baking the bread product; suitable substitutions may also be employed for certain ingredients as or if necessary or appropriate.

### Other Ingredients/Improvers/Variations

According to other exemplary embodiments, as indicated, the formulation of ingredients for the dough component of bread products (including the type or source of flour) and various other ingredients may be varied widely to suit the intent and/or other needs or requirements for a particular application or bread product such as to enhance rise (leavening) and extensibility (e.g. workability of the dough component for the process/procedures).

According to any exemplary embodiment, improvers for the dough components that serve a functional role in the preparation or manufacture of a baked bread product may be employed. Such improvers may comprise the additives and ingredients listed in TABLE 3.

Composition of an example dough component used (for base or fill) in the bread product may comprise any of a wide variety of ingredients and flour types (e.g., wheat flour, rice flour, etc.), along with sugar, yeast, salt, water, oil, etc. in suitable percentages, according to various exemplary embodiments selected and formulated to provide suitable characteristics for the bread product.

As indicated, any ranges provided for ingredients of any dough component according to various exemplary embodiments are approximate; percentage ranges of ingredients could be varied (even widely) according to other exemplary and alternative embodiments. According to various exemplary embodiments, in the formulation of a dough component, bread flour could be replaced with and all-purpose flour or “00” durum flour or other functional flour for the system/method or product. For example, the flour for the dough component could be a blend with constituents/ingredients mixed in a range; for example, approximately 50 percent bread flour and approximately 50 percent all-purpose flour would provide a more tender consistency; small percentages (e.g. around 10 percent of the flour) could include whole wheat flour or other whole grain flours (e.g. quinoa, etc.), in formulations of the dough component that can be adapted according to cultural/popular tastes or other appeal. Such formulations may be developed for the system and method to give the final product distinct texture and flavors (or as part of a marketing strategy targeting certain customer desires, such as for a product that can be considered or perceived as healthier, etc.).

According to various exemplary embodiments, water could be provided in any of a range of percentages; for example, according to one exemplary embodiment, water may be in a range of between approximately 60 and 75 percent (as workable). Other formulations may alter combinations of water and improvers; for example, a wetter dough component (approximately 75 percent hydration) would be more workable if it included approximately 5 percent (vital) wheat gluten. flavorful liquid could be substituted for water (in some form); for example, a tomato-water stock or a mushroom stock may be used to flavor the dough component; other desired flavors may also be put into the dough component through ingredients or other ranges of other additives that are flavorful. According to an exemplary embodiment, tomato/mushroom powders (e.g. approximately 3-5 percent) could be added to the dough component; additions of dried powders (e.g. tomato, mushroom, etc.) would start to build flavors into the dough component before other ingredients are mixed into the dough component. According to various exemplary embodiments, salt could be in approximately a 1-2 percent range. Sugars or other sweeteners may be added to the dough component.

According to various exemplary embodiments, instant yeast concentrations could range up to approximately 1 percent (e.g. depending on how quickly one is trying to manufacture the product). According to an alternative embodiment, fresh yeast may be used (e.g. usually used at about three times the weight of instant yeast, and thus approximately 1-3 percent). Other leavening agents could be used in conjunction with the yeast; for example, encapsulated leavening agents (e.g. in concentrations of approximately 0.25-0.75 percent) may be provided to aid in rise during baking (e.g. will not activate until the dough component reaches a certain temperature).

According to other exemplary embodiments, the dough component for the dough base could be produced using any number of proprietary blends commercially available from suppliers (for example, including various combinations and blends of the ingredients in TABLE 3). According to another exemplary embodiment, the system and method could be implemented and/or adapted to produce non-gluten bread products; for example, gluten-free flours such as rice, oat, amaranth, potato, sorghum, and tapioca could be used in various formulations of a dough component. Gums such as xanthan or carrageenan could be provided as improvers/ingredients for the dough component according to exemplary embodiments. According to an exemplary embodiment, esters (in powder/granular form) may be added as an improver/ingredient to the dough component (e.g. to add fermentative flavor).

It is important to note that the construction and arrangement of the elements of the inventions as described in system and method and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, variations in the arrangement or sequence of process/method steps, operating conditions and arrangement of the preferred and other exemplary embodiments without departing from the spirit of the present inventions.

In the description, reference is made to the accompanying drawings, which form a part of the specification. In the drawings, similar symbols typically identify similar components, unless context dictates otherwise. The illustrative embodiments described in the description, drawings, and claims are not meant to be limiting. Other embodiments may be utilized, and other changes may be made, without departing from the spirit or scope of the subject matter presented in the application.

While various aspects and embodiments have been disclosed in the application, other aspects and embodiments will be apparent to those skilled in the art. The various aspects and embodiments disclosed in the application are for purposes of illustration and are not intended to be limiting, with the true scope and spirit being indicated by the claims as presented and/or amended.

### Tables

TABLE 1

| | PERCENT |
|---|---|
| INGREDIENT | (APPROX.) |
| Bread flour | 100.0 |
| Water | 70.0 |
| Instant yeast | 0.3 |
| Salt | 1.0-2.0 |

TABLE 2

| | PERCENT |
|---|---|
| INGREDIENT | (APPROX.) |
| Bread flour | 100.0 |
| Egg | 40.0 |
| Butter | 22.0 |
| Sugar | 20.0 |
| Milk | 14.0 |
| Water | 13.0 |
| Salt | 1.0-2.0 |
| Yeast | 1.0 |

TABLE 3

| | | AMOUNT | INTENDED OR DESIRED |
|---|---|---|---|
| TYPE | ADDITIVE | (approximate unit percent) | EFFECT |
| Proteins | Gluten | 3-10% of flour (depends | Strengthens dough |
| | | on type of flour) | |
| | Bean flour (fava, | Fava 0-0.2% of flour | Strengthens flour |
| | soybean, etc.) | Soybean 0.2-0.3% of flour | |
| | Whey | to suit | Minor addition of protein; |
| | | | strengthens dough; sugars help |
| | | | browning |
| Enzymes | Transglutaminase | 1% (iterate) | Larger holes; increased volume up to |
| | | | certain concentration; reduces |
| | | | allergenicity of gluten |
| | Amylase (malt) | 1-10% of flour | Breaks down starch to sugars; |
| | | | increased caramelization |
| | Fungal α-amylase | to suit | Sugar for caramelization and feeding |
| | | | yeast; breaks down starch; |
| | | | degrades/softens gluten; useful for |
| | | | producing liquid doughs (crackers, |
| | | | flatbreads) |
| | Protease | to suit | Reduce mixing time (protease) |
| Yeast | Non-rising yeast | to suit | |
| | Inactive yeast | to suit | Add flavor |
| Gums | Guar gum | up to 1% | Tolerance to over mixing; increased |
| | | | water absorption; stronger dough |
| | | | (more resistant to mixing) |
| | Xanthan | 0.1-0.5% | Better crumb structure |
| | Carboxylmethyl | 0.1-0.5% | Increase bread volume |
| | cellulose | | |
| | Locust bean gum | to suit | Extend shelf-life |
| | Alginate | 0.1-0.5% | Anti-staling agent; affects crumb |
| | | | hardness, staling time; increases |
| | | | dough volume |
| | κ-Carrageenan | 0.1-0.5% | |
| Acids | Ascorbic acid | 20-80 mg/kg flour (max | Improves dough strength; increase |
| | (Vitamin C) | 300 mg/kg flour) | loaf volume (e.g. ~20%); decreases |
| | | | length of fermentation, with possibly |
| | | | less organic acid formation and less |
| | | | flavor; oxidation |
| | Lecithin | 0.1-1.0% of flour | Reduces dough stickiness |
| | L-Cysteine | 0.1% | Improves dough extensibility |
| | Citric acid | 0.5% of flour | Less sticky dough |
| Other | Oxygen | to suit | Bleaches dough |
| | Potassium bromate | to suit | Strengthens dough; increases dough |
| | | | volume |
| | Potassium iodate | to suit | Oxiding agent |
| | Azodiacarbonamide | to suit | Oxiding agent |
| | Datem | 0.375-0.5% | Strengthen gluten network |

1-282. (canceled)

283. A multi-component bread product comprising:
a first dough component dispensed as an interior dough mass that will form a crumb of the bread product when the bread product is finished into a baked bread product, the first dough component comprised of a first set of ingredients configured to provide the crumb with a desired characteristic;
a second dough component applied to provide an exterior layer of the first dough component, the second dough component having an exposed surface at which the crust of the bread product will form when the bread product is finished into a baked product, the second dough component comprised of a second set of ingredients different from the first set of ingredients, the second dough component configured to provide the crust with a desired characteristic.

284. The bread product of claim 283 wherein the bread product is finished into a finished bread product by baking.

285. The bread product of claim 283 wherein the characteristics of the crumb comprise at least one of texture, flavor, and appearance.

286. The bread product of claim 283 further including a third dough component deposited as an intermediate layer over the first dough component and wherein the second dough component is deposited over the intermediate layer of the bread product.

287. The bread product of claim 283 wherein the second dough component encapsulates at least the first dough component.

288. The bread product of claim 283 wherein the second dough component partially covers the dough mass.

289. The bread product of claim 283 wherein the second dough component includes a batter.

290. The bread product of claim 283 wherein the second dough component includes a liquid.

291. The bread product of claim 283 wherein the second dough component is deposited at least partially as a sheet over top of the dough mass.

292. The bread product of claim 283 wherein the first dough component is formed into the interior dough mass in a forming operation.

293. The bread product of claim 292 wherein the forming operation includes dispensing of the first dough component into a dough ball.

294. The bread product of claim 292 wherein the forming operation includes extrusion of the first dough component into the interior dough mass.

295. The bread product of claim 292 wherein the forming operation includes extrusion of the second dough component as the exterior layer on the interior dough mass.

296. The bread product of claim 292 wherein the forming operation includes co-extrusion of the first dough component into the interior dough mass and of the second dough component into the exterior layer over the interior dough mass.

297. The bread product of claim 292 wherein the forming operation includes cutting the interior dough mass into a specified length.

298. The bread product of claim 283 wherein the bread product is formed with a forming tool.

299. The bread product of claim 283 wherein the exterior layer is deposited onto the interior dough mass by a deposition operation.

300. The bread product of claim 299 wherein the deposition operation includes deposition of the second dough component in liquid form.

301. The bread product of claim 296 wherein the bread product includes a co-extruded multi-component bread product.

302. The bread product of claim 283 wherein the exterior layer has a generally uniform thickness.

303. The bread product of claim 283 wherein the exterior layer has a varying thickness.

304. A system to produce a multi-component bread product with an interior dough mass formed from a first dough component and an exterior layer formed from a second dough component comprising:
a mixing station configured to mix a first dough component from a first set of ingredients, the first set of ingredients chosen to have a desired set of crumb characteristics when baked, and to mix a second dough component from a second set of ingredients different from the first set of ingredients, the second set of ingredients chosen to have a desired set of crust characteristics when baked;
a forming station configured to form the bread product by dispensing the first dough component into the interior dough mass and applying the second dough component as the exterior layer onto the interior dough mass; and
a finishing station configured to finish the bread product into a finished multi-component bread product.

305. The system of claim 304 wherein the crumb characteristics include texture and flavor and appearance.

306. The system of claim 304 wherein the crust characteristics comprise a crispiness or a crunchiness characteristic.

307. The system of claim 304 wherein finishing the bread product includes baking.

308. The system of claim 304 wherein finishing the bread product includes par-baking.

309. The system of claim 304 wherein finishing the bread product includes freezing.

310. The system of claim 304 wherein forming includes stamping of the dough mass.

311. The system of claim 304 wherein forming includes forming the dough mass with a tool.

312. The system of claim 304 wherein forming includes forming the dough mass simultaneously with the exterior layer.

313. The system of claim 304 further including a third dough component deposited as an intermediate layer over the interior dough mass and wherein the exterior layer is deposited over the intermediate layer.

314. The system of claim 304 wherein the exterior layer encapsulates the dough mass.

315. The system of claim 304 wherein the exterior layer is deposited as a sheet at least partially over the top of the dough mass.

316. The system of claim 304 wherein the bread product includes a co-extruded multi-component bread product.

317. The system of claim 304 wherein the exterior layer has a generally uniform thickness.

318. The system of claim 304 wherein the exterior layer has a varying thickness.

319. A method of producing a multi-component bread product to be finished under operating conditions into a baked bread product comprising the steps of:
mixing a first dough component from a first set of ingredients chosen to have a desired set of crumb characteristics when baked;
mixing a second dough component from a second set of ingredients different from the first set of ingredients and the second set of ingredients chosen to have a desired set of crust characteristics when baked;
forming the bread product by dispensing first dough component into an interior dough mass and depositing second dough component as an exterior layer onto the interior dough mass; and
finishing the bread product into a finished multi-component bread product.

320. An apparatus comprising:
a first dispenser to dispense the first dough component into an interior dough mass, the first dough component made from a first set of ingredients chosen to provide a desired set of crumb characteristics when baked; and
a second dispenser to apply the second dough component as the exterior layer onto the interior dough mass, the second dough component made from a second set of ingredients chosen to provide a desired set of crust characteristics when baked.
